(19) United States
(12) Patent Application Publication
(10) Pub. No.: US 2017/0027179 A1
(43) Pub. Date: Feb. 2, 2017

(54) INSECT REPELLENT COMPOSITION

(71) Applicant: Michelle Lydon, Great Barrington, MA (US)

(72) Inventor: Michelle Lydon, Great Barrington, MA (US)

(21) Appl. No.: 14/813,205

(22) Filed: Jul. 30, 2015

(51) Int. Cl. A01N 65/06; A01N 25/30; A01N 65/08; A01N 65/28; A01N 65/22

(52) U.S. Cl. CPC A01N 65/06; A01N 65/28; A01N 65/22; A01N 65/08; A01N 25/30

(57) ABSTRACT

Embodiments of the invention relate generally to insect repellents and, more particularly, to a novel composition with properties as an insect repellent, an anti-inflammatory, and antipruretic. In one embodiment, the invention provides a composition comprising: a quantity of oil derived from Pelargonium graveolens; a quantity of oil derived from Lavandula sp.; a quantity of oil derived from Melaleuca alternifolia; a quantity of cedarwood oil; a quantity of oil derived from Corymbia citriodora; water; and a surfactant.

### BACKGROUND

Various insect repellents are commercially available. Many contain synthetic chemicals which, while often effective as insect repellents or pesticides, are known to have undesirable properties as well. For example, N,N-Diethyl-meta-toluamide (DEET), is known or suspected of causing insomnia, mood disturbances, impaired cognitive function, and seizures. Similarly, permethrin (3-Phenoxybenzyl (IRS)-cis,trans-3-(2,2-dichlorovinyl)-2,2-dimethylcyclopropanecarboxylate), an insecticide that has been used in liquid insect repellants and flea collars, has been classified as a likely human carcinogen and found capable of causing seizures. At least one study suggested a link between permethrin and Parkinson's disease.

In addition, insect repellants that are considered safe for humans may be harmful to domestic animals, or vice versa. For example, permethrin has been approved for use on humans and dogs, but is fatal to cats. Thus, owners of multiple species of domestic animal must choose very carefully among commercially-available insect repellents to ensure that some species are not unintentionally harmed.

As a consequence, insect repellants composed of naturally-occurring ingredients have, for many people, become attractive alternatives. Many naturally-occurring compounds are known to be useful as insect repellants or antipruritics (anti-itch). Rose geranium (Pelargonium graveolens) oil, for example, has been used as a mosquito repellant. Lavender (Lavandula sp.) oil, tea tree (Melaleuca alternifolia) oil, and lemon eucalyptus (Corymbia citriodora) oil have been used as a tick repellant. Cedarwood oil has been used as a flea repellant. Various known compositions have incorporated one or more of these compounds and been used as insect repellants with varying degrees of efficacy.

### SUMMARY

In one embodiment, the invention provides a composition comprising: a quantity of oil derived from Pelargonium graveolens; a quantity of oil derived from Lavandula sp.; a quantity of oil derived from Melaleuca alternifolia; a quantity of cedarwood oil; a quantity of oil derived from Corymbia citriodora; water; and a surfactant.

### DETAILED DESCRIPTION

Applicant has developed a novel composition including a plurality of oils that provide not only superior properties as an insect repellant, but also antipruritic and antiinflammatory properties. This composition comprises an oil derived from rose geranium (Pelargonium graveolens), an oil derived from lavender (Lavandula sp.), an oil derived from the tea tree (Melaleuca alternifolia), cedarwood oil, an oil derived from lemon eucalyptus (Corymbia citriodora), a surfactant, and water.

Suitable lavender species include, for example, Lavandula spica and Lavandula angustifolia. Cedarwood oil may be derived from any of a number of genera and, within these genera, any number of species. Suitable genera include, for example, Cedrela, Juniperus, Calocedrus, Thuja, Toona, Cupressus, Cryptomeria, and Chamaecyparis. Suitable species for the derivation of cedarwood oil include, for example, Cedrela odorata, Juniperus virginiana, Calocedrus decurrens, Thuja plicata, Thuja occidentalis, Toona ciliata, Cupressus lusitanica, Cryptomeria japonica, and Chamaecyparis lawsoniana.

After experimentation with various oils at various proportions, this particular combination was found to provide significantly superior properties as an insect repellant. In particular, it has been found that the oil ingredients mixed at a proportion of approximately one part tea tree oil to approximately four parts each of rose geranium oil, lavender oil, cedarwood oil, and lemon eucalyptus oil is particularly effective.

To such an oil mixture is added a surfactant in sufficient quantity to ensure dispersion of the oils in water. One skilled in the art will recognize that the amount of surfactant employed will depend, for example, on the properties of the surfactant itself and the proportions of oil mixture and water. Typically, the quantity of surfactant is in proportion to, for example, the rose geranium oil at a ratio of between about 20:1 and about 40:1, preferably between about 30:1 and about 40:1, more preferably about 37:1 (e.g., approximately 1 mL of surfactant to approximately 1.25 oz. (36.9625 mL) of the oil mixture).

Any number of surfactants may be employed in practicing the various embodiments of the invention. Preferably, such surfactants are naturally-occurring or naturally-derived, such as vegetable oil- or olive oil-derived. In some embodiments of the invention, Castile soap is used as a surfactant.

The oil and surfactant mixture may be diluted in any suitable vehicle, typically water. Where water is employed, the ratio of oil and surfactant mixture to water is typically between about 1:4 and about 1:6, preferably between about 1:5 and about 1:6, more preferably about 4:21.

Compositions according to the various embodiments of the invention were tested for their insect repellent properties during summer months in wooded areas of Connecticut, Georgia, Maine, Massachusetts, New Hampshire, New York, Oregon, Rhode Island, Vermont, and Washington. Such testing included applying the liquid compositions via spray bottle to clothing and the coats of domestic dogs and hiking through wooded (deciduous and coniferous) areas and grassed fields. These areas were known through the experience of the testers to include various insect populations, including mosquitoes and ticks (including Ixodes scapularis and Ixodes pacificus).

Testing resulted in significantly fewer instances of insect bites, insect stings, and embedding of ticks as compared to the use of a number of commercially-available insect repellents, including insect repellents containing one or more of the natural oils employed in compositions of the invention. In fact, in an arm-to-arm comparison (compositions of the invention applied to one arm of a tester and a commercially-available insect repellent on the other arm), each tester observed no insect bites on the arm to which a composition according to the invention was applied and an average of three insect bites on the arm to which the competing commercially-available insect repellent was applied. Included among the commercially-available insect repellents used in this testing was Off!® (available from SC Johnson, Racine, Wis.), containing 15% DEET as its active ingredient.

It was also found that compositions comprising fewer than the five oils noted above were less effective as insect repellents, even where the total quantity of oils was the same. In other words, the results suggest that it is the particular combination of these five oils that imparts the superior properties as an insect repellent.

In addition to improved properties as an insect repellent, it was surprisingly found that compositions according to the various embodiments of the invention also exhibited anti-inflammatory and antipruritic properties. During testing of the compositions according to the invention, human subjects were exposed to poison ivy (Toxicodendron radicans) prior to application of the composition. Itching and swelling typical of exposure to poison ivy was noted and, upon application of the composition, marked attenuation of both itching and inflammation was observed.

This result suggests that compositions according to the invention may be useful as an antipruritic and/or an anti-inflammatory treatment following exposure not only to poison ivy, but to other plants containing urushiol, the compound responsible for the itching and swelling associated with poison ivy exposure. Other urushiol-containing plants include, for example, poison oak, poison sumac, and the lacquer tree, each of which is capable of causing urushiol-induced contact dermatitis.

The various embodiments of the invention described herein are intended to be illustrative and not limiting in general or to the particular forms described. Modifications and additions to the embodiments described herein will be apparent to one of ordinary skill in the art and are within the scope of the invention as defined by the accompanying claims.

What is claimed is:

1. A composition comprising:
a quantity of oil derived from Pelargonium graveolens;
a quantity of oil derived from Lavandula sp.;
a quantity of oil derived from Melaleuca alternifolia;
a quantity of cedarwood oil;
a quantity of oil derived from Corymbia citriodora;
water; and
a surfactant.

2. The composition of claim 1, wherein the quantity of oil derived from Lavandula sp. includes oil derived from a group consisting of: Lavandula spica and Lavandula angustifolia.

3. The composition of claim 1, wherein the quantity of cedarwood oil includes oil derived from a group consisting of: Cedrela sp., Juniperus sp., Calocedrus sp., Thuja sp., Toona sp., Cupressus sp., Cryptomeria sp., and Chamaecyparis sp.

4. The composition of claim 3, wherein the quantity of cedarwood oil includes oil derived from a group consisting of: Cedrela odorata, Juniperus virginiana, Calocedrus decurrens, Thuja plicata, Thuja occidentalis, Toona ciliata, Cupressus lusitanica, Cryptomeria japonica, and Chamaecyparis lawsoniana.

5. The composition of claim 1, wherein the surfactant includes at least one of a vegetable oil-based soap or an olive oil-based soap.

6. The composition of claim 1, wherein the quantity of oil derived from Pelargonium graveolens, the quantity of oil derived from Lavandula sp., the quantity of oil derived from Melaleuca alternifolia, the quantity of cedarwood oil, and the quantity of oil derived from Corymbia citriodora are in a ratio of approximately 4:4:1:4:4.

7. The composition of claim 6, wherein the ratio of total oil content to water is between about 1:4 and about 1:6.

8. The composition of claim 7, wherein the ratio of total oil content to water is between about 1:5 and about 1:6.

9. The composition of claim 7, wherein the ratio of total oil content to water is about 4:21.

10. The composition of claim 1, wherein the surfactant is present in a quantity sufficient to ensure blending of each of the oils with the water.

11. The composition of claim 10, wherein the ratio of total oil content to surfactant is between about 20:1 and about 40:1.

12. The composition of claim 11, wherein the ratio of total oil content to surfactant is between about 30:1 and about 40:1.

13. The composition of claim 12, wherein the ratio of total oil content to surfactant is about 37:1.
